(19) United States
(12) Patent Application Publication
(10) Pub. No.: US 2009/0250962 A1
(43) Pub. Date: Oct. 8, 2009

(54) DEPLOYABLE STORAGE SYSTEM FOR A VEHICLE BED

(75) Inventors: Joseph M. Polewarczyk, Rochester Hills, MI (US); Kevin G. Kolpasky, Oakland Township, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/099,543

(22) Filed: Apr. 8, 2008

(51) Int. Cl. B62D 33/03; B61D 45/00

(52) U.S. Cl. 296/57.1; 410/129; 410/135; 296/37.6

(57) ABSTRACT

A deployable storage system for a vehicle bed is provided. The vehicle bed is partly defined by a tailgate, first and second opposing side walls and a floor. The deployable storage system includes a panel assembly secured to and that may be nested within at least one of the tailgate, the side walls and the floor of the vehicle, and movable between a stowed position and a deployed position. The panel assembly does not enclose the bed when in the stowed position and generally defines along with the tailgate, the walls and the floor, an enclosure of a portion of the bed adjacent the tailgate when in the deployed position. Because the deployable storage system encloses a rear portion of the vehicle bed, air drag on the vehicle is reduced.

### TECHNICAL FIELD

The invention relates to a deployable storage system for a vehicle bed, such as a pickup truck bed.

### BACKGROUND OF THE INVENTION

Pickup trucks are useful for hauling oversized cargo too large to fit within the trunk of a typical passenger car. However, cargo in the bed of a pickup is generally not secure unless a lockable tool box or tonneau cover is used. Special attention must be given to the design of a pickup, as the extended bed may create drag, reducing fuel economy.

### SUMMARY OF THE INVENTION

A deployable storage system for a vehicle bed is provided. The vehicle bed is partly defined by a tailgate, first and second opposing side walls and a floor. The deployable storage system includes a panel assembly secured to and that may be nested within at least one of the tailgate, the side walls and the floor of the vehicle, and movable between a stowed position and a deployed position. The panel assembly does not enclose the bed when in the stowed position and generally defines along with the tailgate, the walls and the floor, an enclosure of a portion of the bed adjacent the tailgate when in the deployed position. Because the deployable storage system encloses a rear portion of the vehicle bed, air drag on the vehicle is reduced.

The deployable storage system may include opposing support assemblies secured to the opposing side walls and configured to support the panel assembly in the deployed position. A seal on each support assembly is configured to seal the panel assembly to the respective opposing support assemblies when in the deployed position. Lateral storage containers may be incorporated in the opposing support assemblies.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective illustration of a first embodiment of a vehicle with a deployable storage system shown in a stowed position nested in a floor;

FIG. 2 is a schematic perspective illustration of the deployable storage system of FIG. 1 in a first intermediate position;

FIG. 3 is a schematic perspective illustration of the deployable storage system of FIGS. 1-2 in a second intermediate position;

FIG. 4A is a schematic side illustration of the deployable storage system of FIGS. 1-3 in a deployed position with a tailgate shown in phantom in an open position;

FIG. 4B is a schematic side illustration of a locking tab secured to a support of the deployable storage system to support a second panel in the deployed position and shown in phantom in a released position;

FIG. 5 is a schematic perspective illustration of the deployable storage system of FIGS. 1-4B with the tailgate in an open position and a cargo net secured to span the vehicle bed;

FIG. 6 is a schematic perspective illustration of a vehicle with a second embodiment of a deployable storage system that is integrated in a bed insert;

FIG. 7 is a schematic perspective illustration of a vehicle with a third embodiment of a deployable storage system shown in a deployed position and, in phantom, in a stowed position nested in the tailgate;

FIG. 8 is a schematic perspective illustration of a fourth embodiment of a deployable storage system shown in a stowed position nested in a bed divider;

FIG. 9 is a schematic perspective illustration of the deployable storage system of FIG. 8 in a deployed position;

FIG. 10 is a schematic perspective illustration of a fifth embodiment of a deployable storage system in a stowed position; and

FIG. 11 is a schematic perspective illustration of the deployable storage system of FIG. 10 in the deployed position.

### DESCRIPTION OF THE PREFERRED EMBODIMENTS

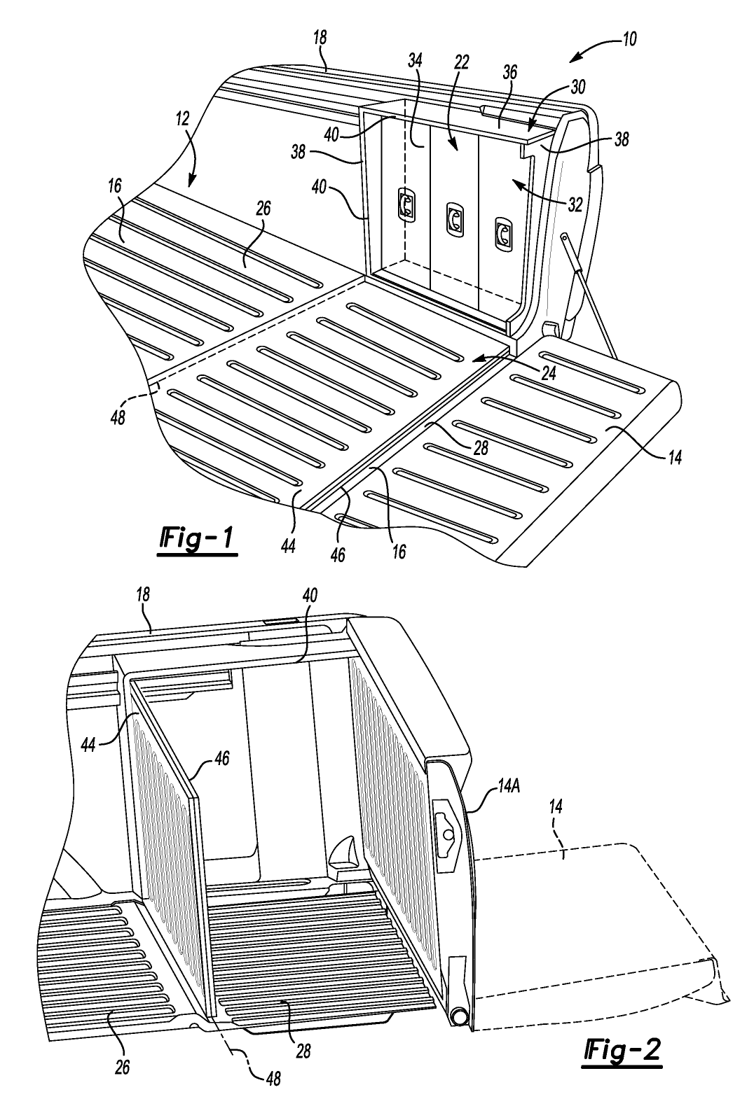

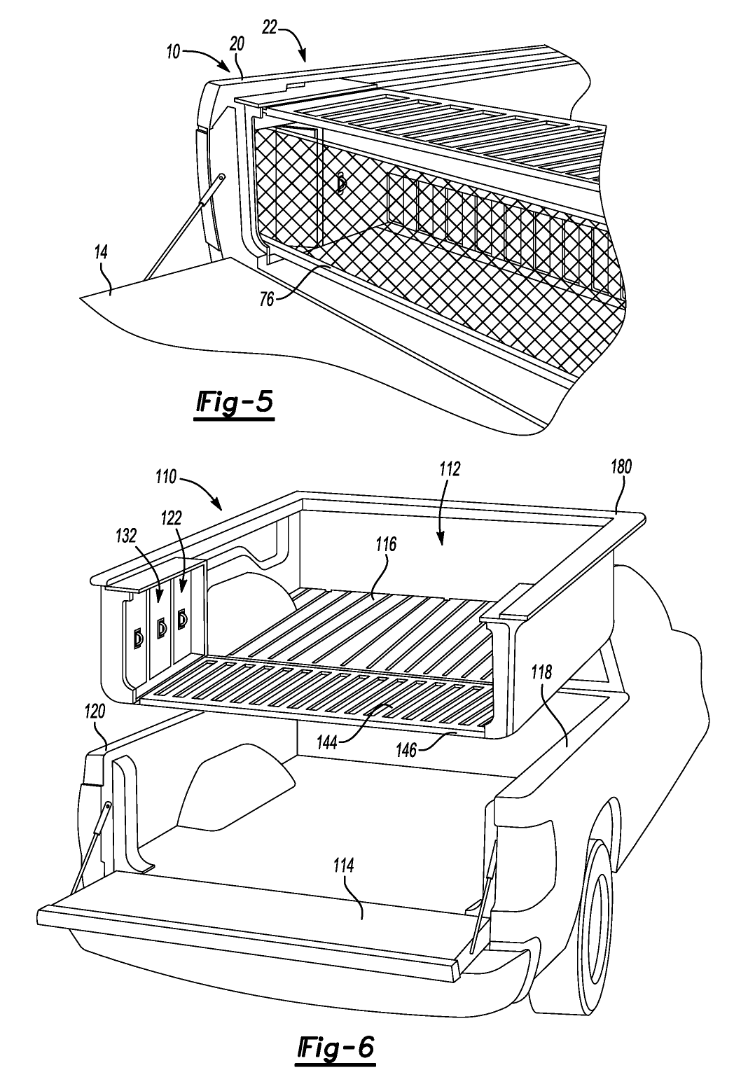

Referring to the drawings, wherein like reference numbers refer to like components, FIG. 1 shows a portion of a vehicle 10 with a truck bed 12 that is defined in part by a tailgate 14, a floor 16, a first side wall 18 and a second side wall 20 (shown in FIG. 5, and substantially identical to and a mirror image of the first side wall 18, but removed for clarity in FIGS. 1-4A). A deployable storage system 22 is secured to the vehicle 10 at a rearward portion of the bed 12. The deployable storage system 22 includes a panel assembly 24 nested in the floor 16 in a stowed position in FIG. 1. As best shown in FIG. 2, the floor 16 has an upper portion 26 and a lower portion 28, creating a slight recess above the lower portion 28 so that the panel assembly 24 can rest above the lower portion 28 in the recess when in the stowed position, substantially integral with the floor 16, and substantially flush with the upper portion 26.

Referring again to FIG. 1 the deployable storage system 22 also includes support assemblies 30 on either lateral side of the bed 12, one adjacent the first side wall 18 and another adjacent the second side wall 20 (not shown, but substantially identical to and a mirror image of the support assembly 30 adjacent the first side wall 18). The support assembly 30 has a lateral storage container 32 with movable doors 34 that selectively close off a storage space defined by an upper support 36 and side supports 38 of the support assembly 30 and the first side wall 18. (The doors 34 are removed in FIG. 2 to better show the side wall 18.) A seal 40 runs along the edge of the support assembly 30 facing laterally inward to form a seal with the panel assembly 24 when it is in the deployed position of FIG. 4A.

The panel assembly 24 includes a first panel 44 and a second panel 46, pivotably hinged to one another. When the panel assembly 24 is in the stowed position of FIG. 1, the first panel 44 rests on top of the second panel 46 with a face 50 of first panel 44 facing a face 52 of the second panel 46 (faces 50 and 52 best indicated in FIG. 4A). The first panel 44 is secured to the floor 16 and pivotable about pivot axis 48 (see FIG. 1) with respect to the floor 16. The second panel 46 is not secured to the floor 16, except indirectly, by virtue of being pivotably secured to the first panel 44.

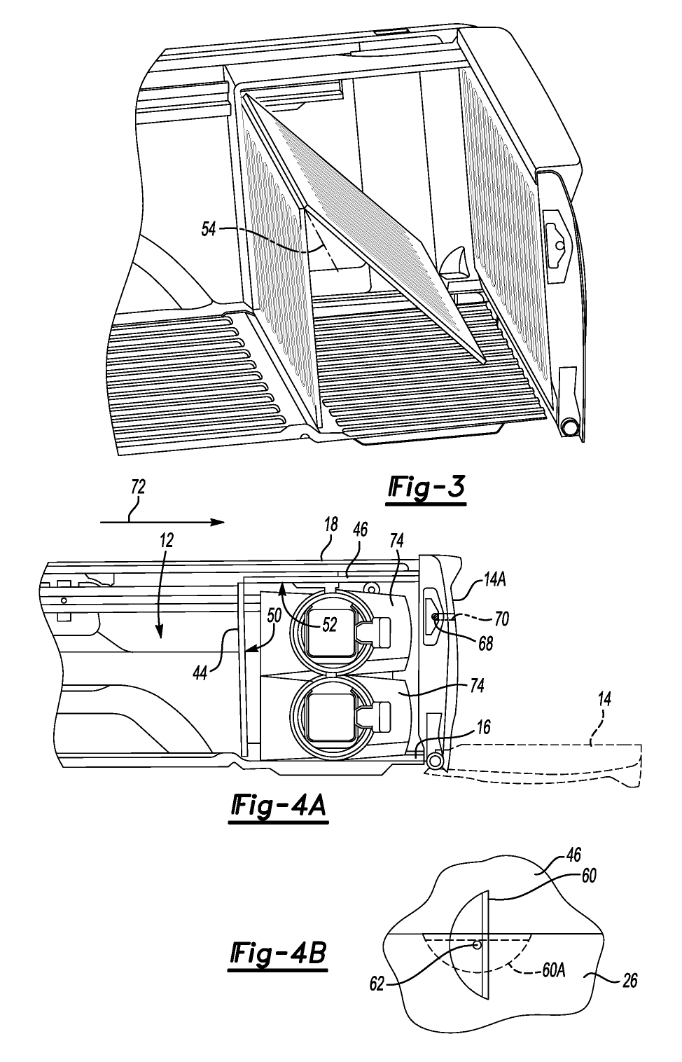

To selectively move the panel assembly 24 from the stowed position of FIG. 1 to the deployed position of FIG. 4A, first, both panels 44, 46 are rotated upward from the floor 16 about pivot axis 48, remaining face to face, to the intermediate position of FIG. 2 in which both panels 44, 46 are substantially vertical. The tailgate 14 would most likely be in the open position indicated in phantom as 14 in FIG. 2, rather than in the closed position (indicated as 14A) during the positioning of the panel assembly 24. Next, the second panel 46 is rotated upward about pivot axis 54, apart from the first panel 44, as indicated in an intermediate position in FIG. 3, to the final deployed position of FIG. 4A.

As shown in FIG. 4B, viewing a fragmented portion of the second panel 46 and the upper portion 26 from below, a locking tab 60, also referred to as a quarter-turn, is shown in a locking position, supporting the panel 46 in the deployed position. The locking tab is pivotable about a pin 62, which connects the tab 60 to the upper portion 26, from a release position indicated as 60A in phantom. One or more locking tabs 60 may be secured to both opposing upper portions 26 to support the panel 46.

In the deployed position, the deployable storage system 22 creates an enclosure of a rear portion of the bed 12, with the enclosure partially defined by the closed tailgate 14A, the panels 44, 46, the support assemblies 30, the side walls 18, 20, and the floor 16. The tailgate 14A is lockable in any of the known mechanisms, such as by a lever 68 extending sideways into the side walls 20, 22. Locking the tailgate 14A secures items stored in the enclosure. In FIG. 4A, golf bags 74 are shown stored in the enclosure. A locking mechanism 70 in the tailgate 14A is selectively locked. Thus, the deployable storage system 22 provides a selectively available trunk. With the deployable storage system 22 located at the rear of the bed 12, a rearward directed airstream 72, such as an airstream developed by forward travel of the vehicle 10, is prevented from collecting at the rearmost portion of the bed 12 (i.e., the portion enclosed by the storage system 22). Those skilled in the art of vehicle design recognize that preventing air flow at the rear of the bed 12 potentially eliminates vehicle drag, which in turn improves fuel economy.

Referring to FIG. 5, the deployable storage system 22 is shown with an optional cargo net 76 spanning the bed 12 between the side wall 20 and side wall 18 (shown in FIG. 1).

Referring to FIG. 6, a vehicle 110 is shown with a unitary bed insert 180 defining a vehicle bed 112 and into which a deployable storage system 122 is integrated. The unitary bed insert 180 may be a hard plastic or other suitable material, and is sized to fit within the vehicle 110 between the side walls 128, 120. The deployable storage system 122 is substantially similar to deployable storage system 22 of FIGS. 1-4B and includes first and second panels 144, 146 nested in a floor 116 formed in the insert 180, as well as lateral storage containers 132. The panels 144, 146 are movable with respect to the floor 116 in the same manner as panels 44, 46 of FIGS. 1-4A, and define an enclosure with tailgate 114 when tailgate 114 is in a closed position.

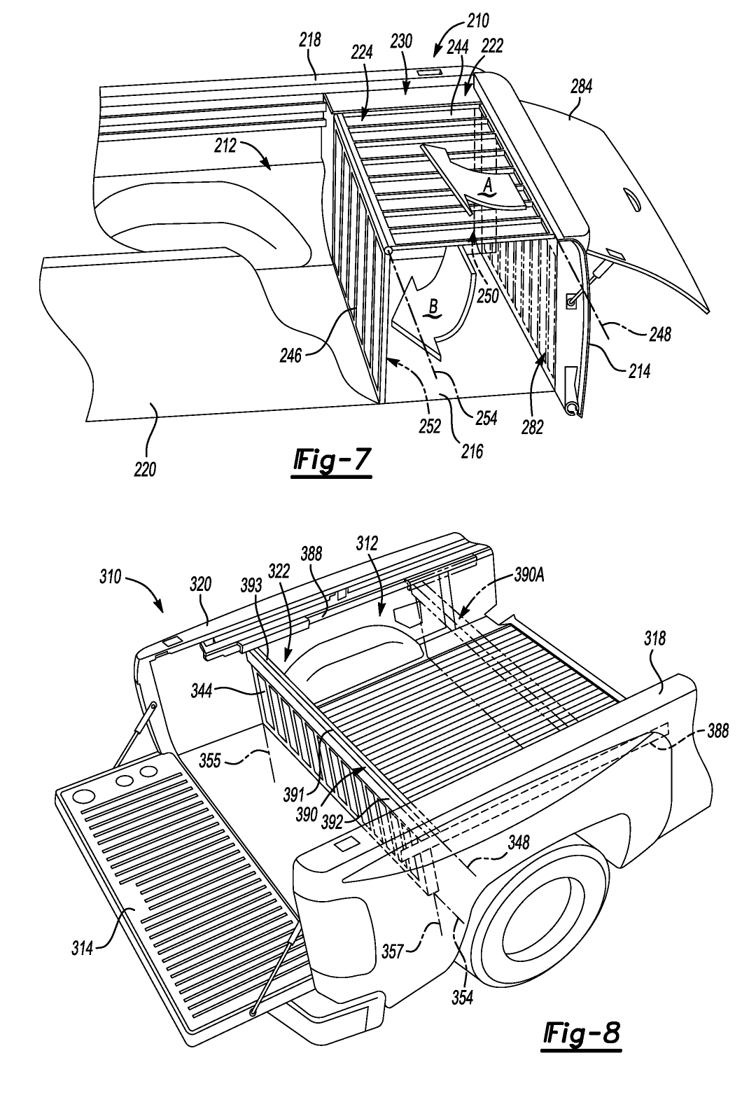

Referring to FIG. 7, a vehicle 210 is shown with a deployable storage system 222 shown in a deployed position partially defining an enclosure at the rear portion of a vehicle bed 212. The deployable storage system 222 includes a panel assembly 224 having a first panel 244 hinged to a second panel 246. The panel assembly 224, a vehicle side wall 218, support assembly 230, another vehicle side wall 220 (shown only in fragment, but a mirror image of side wall 218 on the other side of the panel assembly 224, and another support assembly 230 adjacent side wall 220 and that is a mirror image of the support assembly 230 shown) as well as the vehicle floor 216 and tailgate 214 further define the enclosure. In a stowed position, shown in phantom, the panel assembly 224 is stowed or nested within a cavity 282 within the tailgate 214. In the stowed position, the first panel 244 and second panel 246 are face to face with one another, with the face 250 of first panel 244 (i.e., the surface facing downward in the deployed position) facing the face 252 of second panel (i.e., the surface facing rearward in the deployed position). An outer panel 284 of the tailgate 214 is openable, as shown in FIG. 7, to access the panels 244, 246, and move them to the deployed position. The first panel 244 is hinged, via any type of hinge, to the upper portion of the tailgate 214, and is pivotable about an axis of rotation 248 in the direction of arrow A to a generally horizontal position. The second panel 246 is hinged to the first panel 244 and pivots about an axis of rotation 254 in the direction of arrow B to the final deployed position. With the outer panel 284 closed and the tailgate 214 locked via a typical locking mechanism, as described with respect to tailgate 14, the enclosure at the rear of the bed 212 defined partially by the deployed panel assembly 224 secures cargo and reduces drag on the vehicle 210. The panel assembly 224 may be returned to the stowed position by reversing the steps described above. The support portions may house lateral storage containers, similar to those shown and described with respect to FIG. 1. Optionally, a cargo net such as that described with respect to FIG. 5 may be used to further secure the enclosure when the tailgate 214 is open.

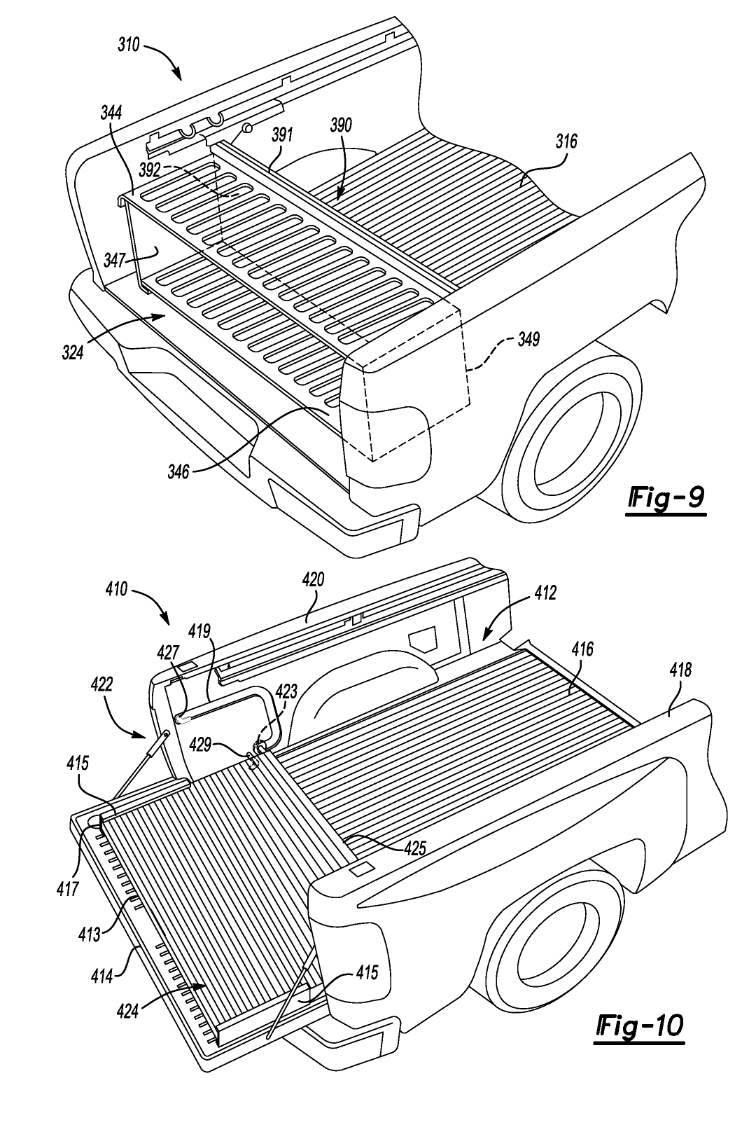

Referring to FIGS. 8 and 9, a vehicle 310 is shown with a deployable storage system 322. The deployable storage system 322 is shown in a stowed position in FIG. 8 and in a deployed position in FIG. 9, partially defining an enclosure at the rear portion of a vehicle bed 312. The deployable storage system 322 includes opposing lateral rails 388 (driver-side rail shown in FIG. 8 secured to the side wall 320, with an opposing lateral rail substantially identical to and a mirror image of the lateral rail 388 shown in phantom, secured to the opposing side wall 318). The deployable storage system 322 includes a bed divider 390 which includes a transverse rail 391 and a panel 392 extending downward therefrom (not visible in FIG. 8, but facing forward opposite panel 344), secured to sliding tubes 393 having a C-shaped cross-section that are slidable along the lateral rails 388 so that the bed divider 390 moves fore and aft in the bed 312. The bed divider 390 is shown in a forward position in phantom in FIG. 8 in which it is referred to as 390A. The bed divider permits the bed 312 to be divided in differently-sized portions depending on the position of the bed divider 390. Locks or clamps may be used to secure a selected position of the bed divider 390 with respect to the rails 388.

The deployable storage system 322 includes a panel assembly 324 having four panels pivotable secured to the bed divider 390 and rotatable outward to deployed positions shown in FIG. 9. Specifically, a first panel 344 shown facing rearward in FIG. 8 rotates upward about an axis of rotation 348 to a deployed position in FIG. 9. A second panel 346 stacked behind the first panel 344 in FIG. 8 pivots downward about an axis of rotation 354 to a deployed position in FIG. 9 in which it is generally horizontal along a portion of the floor 316. The tailgate 314 of FIG. 8 is removed in FIG. 9 for clarity. Next, a third panel 347 rotates outward about an axis of ration 355 to the deployed position of FIG. 9. A like fourth panel 349 (not visible in FIGS. 8 and 9 but indicated in phantom in FIG. 9) that is a mirror image of third panel 347, rotates outward about an axis of rotation 357 to a like substantially vertical and laterally-facing position such as that of the third panel 347. The bed divider 390 forms the back side of the enclosure, spanning between the side walls 318, 320. In the stowed position of FIG. 8, the panel assembly 324 is stowed below the transverse rail of the bed divider 390 forward of the panel 392, shown in phantom. With the tailgate 314 closed and locked via a typical locking mechanism, as described with respect to tailgate 14, the enclosure at the rear of the bed 312, defined partially by the deployed panel assembly 324, secures cargo and reduces drag on the vehicle 310. The panel assembly 324 may be returned to the stowed position by reversing the steps described above. Because of the sliding nature of the bed divider 390, the third and fourth panels 347, 349 are used to form the sides of the enclosure, rather than fixed support assemblies. Optionally, a cargo net such as that described with respect to FIG. 5 may be used to further secure the enclosure when the tailgate 314 is open.

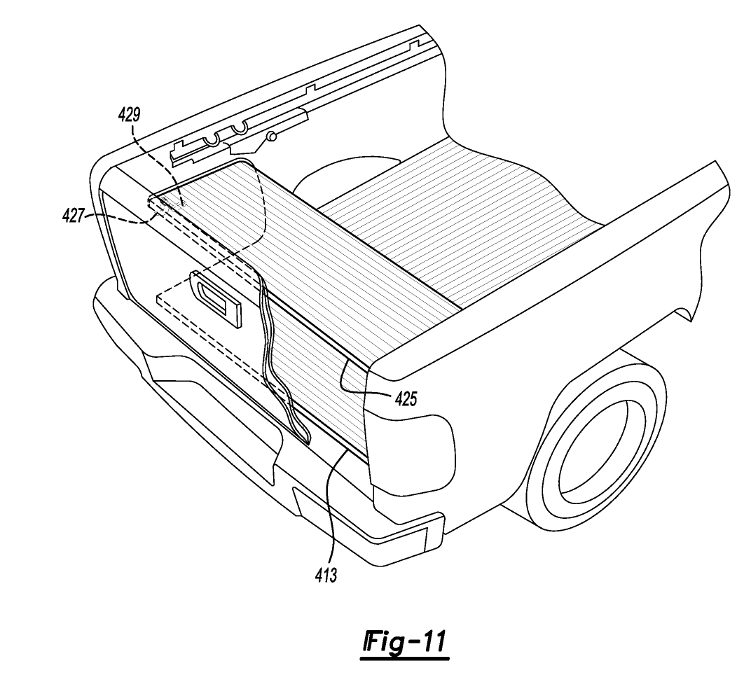

FIGS. 10 and 11 show a vehicle 410 with a deployable storage system 422. The deployable storage system 422 is shown in a stowed position in FIG. 10 and in a deployed position in FIG. 11, partially defining an enclosure at the rear portion of a vehicle bed 412. The deployable storage system 422 includes a panel assembly 424 which has numerous very narrow panels hinged to one another as in a “roll-top desk” or “bread box” design. In the stowed position, the panel assembly 424 nests partially within a recess of the vehicle floor 416, similar to the recess in the floor 16 of FIG. 2. Guide tracks 415 secured to the tailgate 414 on either side of the panel assembly 424 secure rollers 417 at the rear edge 413 of the panel assembly 424 such that the panel assembly 424 is slidably secured to the tailgate 414. Additional curved guide tracks 419 are secured to the vehicle side walls 418, 420 (only guide track 419 secured to side wall 420 is visible in FIGS. 10 and 11, but a substantially identical guide track 419 that is a mirror image of that shown is secured to side wall 418). The guide tracks 419 may be c-shaped in cross-section. A roller 423 at the forward edge 425 of the panel assembly 424 is captured in the guide track 419 in each of the side walls 418, 420. When the tailgate 414 is lowered, the panel assembly 424 would move with it, and would slide a bit as the length of line changed. In other words, the panel assembly 424 remains nested above the bed floor 416, and the change in length is accommodated in the tailgate 414.

Referring to FIG. 11, the panel assembly 424 may be moved to the deployed position by rolling or sliding the panel assembly 424 along a path determined by the guide tracks 419 such that the edge 425 abuts the tailgate 414 (when closed) and the edge 413 remains along the floor of the bed 416, ending at the lower portion of the tracks 415. A spring-loaded latch 427 is positioned along the guide track 419 (either a latch 419 is on one or both guide tracks 419) and is positioned to interact with a catch 429 secured to the panel assembly 424. The catch 429 moves over the spring-loaded latch 427 to a position behind it, and the spring-loaded latch 427 returns to a biased position such that the catch 429 is trapped rearward of the latch 427, thus latching the panel assembly 424 from inside in the deployed position. An enclosure formed at the rear of the bed 412 by the panel assembly 424, the floor 416, the side walls, 418, 420, and the tailgate 414 is thus secured when the tailgate 414 is closed and locked. To return the panel assembly 424 to the stowed position, the tailgate 414 is opened and the latch 427 is depressed to release the panel assembly 424, which is then manually slid back to the stowed position. The tailgate 414 may then be closed, with the panel assembly 424 then largely blanketing the tailgate 414 and the rear part of the floor 416, and not extending beyond the beginning of the tracks 419.

While the best modes for carrying out the invention have been described in detail, those familiar with the art to which this invention relates will recognize various alternative designs and embodiments for practicing the invention within the scope of the appended claims.

1. A deployable storage system for a vehicle bed; wherein the vehicle bed is partly defined by a tailgate, first and second opposing side walls and a floor, the deployable storage system comprising:
a panel assembly secured to at least one of the tailgate, the side walls and the floor and movable between a stowed position and a deployed position; wherein the panel assembly does not enclose the bed when in the stowed position and generally defines with the tailgate, the walls and the floor an enclosure of a portion of the bed adjacent the tailgate when in the deployed position.

2. The deployable storage system of claim 1, further comprising:
a locking mechanism operable to selectively lock the panel assembly in the deployed position to thereby prevent access to the enclosed portion.

3. The deployable storage system of claim 1, wherein the panel assembly is substantially integral with and at least partially nested within the tailgate in the stowed position.

4. The deployable storage system of claim 1, wherein the panel assembly is substantially integral with and at least partially nested within the floor in the stowed position.

5. The deployable storage system of claim 1, further comprising:
opposing support assemblies secured to the opposing side walls and configured to support the panel assembly in the deployed position; a respective seal on each of the opposing support assemblies configured to seal the panel assembly to the respective opposing support assembly when the panel assembly is in the deployed position.

6. The deployable storage container of claim 5, wherein each of the opposing support assemblies has a lateral storage container within the enclosure.

7. The deployable storage system of claim 1, wherein the tailgate is pivotable to an open position, and further comprising:
a cargo net configured to span the bed between the opposing side walls to partially define the enclosure when the tailgate is in the open position.

8. The deployable storage system of claim 1, wherein the first and second opposing side walls and the floor are integrated in a unitary bed insert connected to the vehicle.

9. The deployable storage system of claim 1, further comprising:
opposing lateral rails running longitudinally along the opposing side walls;
a generally vertical bed divider connected with the lateral rails and operable for sliding fore and aft in the bed along the rails; and wherein the panel assembly is integral with the bed divider and is at least partially nested therein in the stowed position.

10. The deployable storage system of claim 1, further comprising:
guide tracks secured to the opposing side walls; and wherein the panel assembly is secured to the guide tracks and configured to be movable between the stowed and deployed positions along a path defined by the guide tracks.

11. A deployable storage system for a vehicle bed; wherein the vehicle bed is partly defined by a tailgate, first and second opposing side walls and a floor, the deployable storage system comprising:
a plurality of panels; wherein each panel has opposing first and second faces; wherein the panels are hinged to one another and configured to be movable between a collapsed position and a deployed position; wherein the panels are collapsed together generally face to face and generally nested within one of the tailgate and the floor in the collapsed position; and wherein the panels are pivoted apart from one another in the deployed position to enclose a portion of the vehicle bed adjacent the tailgate.

12. The deployable storage system of claim 11, further comprising:
a locking mechanism operable to selectively lock the panel assembly in the deployed position.

13. The deployable storage system of claim 11, wherein the panel assembly is substantially integral with and at least partially nested within the tailgate in the stowed position.

14. The deployable storage system of claim 11, wherein the panel assembly is substantially integral with and at least partially nested within the floor in the stowed position.

15. The deployable storage system of claim 11, further comprising:
opposing support assemblies secured to the opposing side walls and configured to support the panel assembly in the deployed position;
a respective seal on each of the opposing support assemblies configured to seal the panel assembly to the respective opposing support assembly when the panel assembly is in the deployed position; and
wherein each of the opposing support assemblies has a lateral storage container.

16. The deployable storage system of claim 11, wherein the tailgate is pivotable to an open position, and further comprising:
a cargo net configured to span the bed between the opposing side walls to partially define the enclosure when the tailgate is in the open position.

17. The deployable storage system of claim 11, wherein the first and second opposing side walls and the floor are integrated in a unitary bed insert connected to the vehicle.

18. A deployable storage system for a vehicle bed; wherein the vehicle bed is partly defined by a tailgate, first and second opposing side walls and a floor, the deployable storage system comprising:
opposing lateral rails running longitudinally along the opposing side walls;
a generally vertical bed divider connected with the lateral rails and operable for sliding fore and aft in the bed along the rails; and
a plurality of panels; wherein each panel has opposing first and second faces; wherein the panels are hinged to one another and configured to be movable between a collapsed position and a deployed position; wherein the panels are collapsed together generally face to face and generally nested within the bed divider in the collapsed position; and wherein the panels are pivoted apart from one another in the deployed position to enclose a portion of the vehicle bed adjacent the tailgate.
